(19) United States
(12) Patent Application Publication
(10) Pub. No.: US 2013/0268930 A1
(43) Pub. Date: Oct. 10, 2013

(54) PERFORMANCE ISOLATION WITHIN DATA PROCESSING SYSTEMS SUPPORTING DISTRIBUTED MAINTENANCE OPERATIONS

(71) Applicants: Ali SAIDI, Austin, TX (US); Stuart David Biles, Bury St. Edmunds (GB); Simon John Craske, Cambridge (GB)

(72) Inventors: Ali SAIDI, Austin, TX (US); Stuart David Biles, Bury St. Edmunds (GB); Simon John Craske, Cambridge (GB)

(73) Assignee: ARM LIMITED, Cambridge (GB)

(21) Appl. No.: 13/441,400

(22) Filed: Apr. 6, 2012

(51) Int. Cl. G06F 9/455

(52) U.S. Cl. 718/1

(57) ABSTRACT

A data processing system 2 incorporates a plurality of processing elements 4, 6, 8, 10, 12 which may exchange broadcast maintenance messages, such as local instruction cache invalidation messages. Behaviour modification circuitry disposed either at the request generator, the request receiver or on route serves to modify the broadcast maintenance requests if one or more predetermined conditions are met. The predetermined conditions may include a message rate being exceeded, a message being redundant due to a preceding message, etc.

### BACKGROUND OF THE INVENTION

1. Field of the Invention

This invention relates to the field of data processing systems. More particularly, this invention relates to data processing systems having processing elements (processor cores) executing respective program streams and which support distributed maintenance operations.

2. Description of the Prior Art

It is known to provide data processing systems incorporating a plurality of processing cores which together accomplish the overall desired processing for the system. The processing cores may share data and this data may be cached locally to each core. Accordingly, there is a need for coherency mechanisms to ensure data coherency at a desired level between different copies of data held within different storage locations of the overall system. In order to support such coherence mechanisms it is known to provide broadcast maintenance requests (messages) which are broadcast from one processing device and actioned by receiving processing devices.

It is also known to provide data processing systems that support use of a plurality of different virtual machine execution environments. These different virtual machine execution environments may, for example, support different operating systems each executing their own application programs. The plurality of operating systems may be overseen by a hypervisor program which controls the allocation of the physical processing resources to the individual guest operating systems and seeks to isolate the different guest operating systems from one another.

### SUMMARY OF THE INVENTION

Viewed from one aspect the present invention provides apparatus for processing data comprising:

a plurality of processing elements each configured to execute a stream of program instructions, said plurality of processing elements providing a plurality of virtual machine execution environments; wherein

at least one of said plurality of processing elements is a broadcast request generating processing element having broadcast generating circuitry configured to generate a first broadcast maintenance request in respect of a given one of said plurality of virtual machine execution environments;

at least one of said plurality of processing elements is a broadcast request receiving processing element having broadcast receiving circuitry configured to receive said first broadcast maintenance request from said broadcast generating processing element and to trigger a maintenance operation in said broadcast receiving processing element in response said first broadcast maintenance request; said apparatus further comprising:

behaviour modifying circuitry configured to modifying behaviour of a further broadcast maintenance request in respect of said given one of said plurality of virtual machine execution environments if a predetermined condition is met.

The present invention recognises that in the context of a data processing system having a plurality of processing elements, each executing a respective stream of program instructions and supporting a plurality of virtual machine execution environments, there exists a potential problem with broadcast maintenance requests. More particularly, broadcast maintenance requests from one processing element supporting a given virtual machine execution environment will normally be sent to all of the other processing elements and, even if those processing elements do not need to perform the specified maintenance operation, the receipt and handling of the broadcast maintenance request can adversely impact the performance of those other processing elements. For example, a broadcast generating processing element supporting a given virtual machine execution environment may generate a broadcast maintenance request indicating that other processing elements should flush their local instruction cache. It may be appropriate in some circumstances for this to take place on all of the other processing elements irrespective of which virtual machine execution environment they are currently hosting, but if the broadcast maintenance request is repeatedly sent and actioned by all of the other processing elements, then the performance of those other processing elements will be significantly reduced. The performance impact may be such that the other processing elements are even prevented from making forward progress in their processing operations. The inappropriate sending of broadcast maintenance requests may be the result of an error in programming, but it is also possible that it could be the result of some malicious action, such as a desire to inflict a denial of service attack on the system by overwhelming the system with inappropriate broadcast maintenance requests.

Having recognised the above problem, the present technique provides the solution of behaviour modifying circuitry that serves to modify the behaviour of a further broadcast maintenance request in respect of a given virtual machine execution environment which generated a first broadcast maintenance request if a predetermined condition is met. The modification to the behaviour of the further broadcast maintenance request could take a variety of different forms depending on the particular implementation. The predetermined condition could also take a variety of different forms depending upon the particular implementation.

The problems of potentially inappropriate generation of broadcast maintenance requests are increased in likelihood within systems in which the broadcast maintenance requests are generated in response to execution of broadcast specifying instructions. Providing such broadcast specifying instructions, particularly if they are accessible in a user mode or a guest operating system mode, as opposed to solely being accessible in hypervisor mode, increases the likelihood of the inappropriate generation of broadcast maintenance requests that can adversely impact the performance of other processing elements within the system and act against the desirable aim of performance isolation between virtual machine execution environments.

The behaviour of the broadcast maintenance request may be modified in a fixed manner. In other embodiments the behaviour of the further broadcast maintenance request may be modified in a manner dependent upon information from said first broadcast maintenance request. Adapting the manner in which the behaviour of the further broadcast maintenance request is modified based on information from the first broadcast maintenance request enables the response of the behaviour modifying circuitry to be matched better to the prevailing system state.

In some embodiments the predetermined behaviour may be modified based upon virtual machine execution environment state held within either or both of the broadcast generating processing element and/or the broadcast receiving processing element. Thus, the modification can be adapted to the particular virtual machine execution environments currently being hosted by different processing elements within the overall system.

It is also possible that the predetermined behaviour may be modified based upon the virtual machine execution environment state of another of the processing elements that is not either the broadcast generating processing element or the broadcast receiving processing element. It is possible that virtual machine state held on some third party processing element within the system can be used to adapt the modification of the further maintenance request in a manner more appropriate to the circumstances existing.

One form of modification of the behaviour of the further broadcast maintenance request is to stall completion of a further broadcast specifying instruction and thereby defer generation of the further broadcast maintenance request. This effectively suppresses generation of the further broadcast maintenance request at source.

Another form of modification may be to upgrade the broadcast maintenance request to an upgraded maintenance request operation that has a larger scope than and includes a further maintenance operation directly corresponding to the further broadcast maintenance request. As an example, the behaviour modifying circuitry may identify that multiple broadcast maintenance requests had been received, each seeking to invalidate a selected subset of cached data within the broadcast receiving processing element. The behaviour modifying circuitry can respond by upgrading one of these broadcast maintenance requests to flush all of the cache data concerned from the broadcast receiving processing element and thereby avoid the need to respond to any subsequent broadcast maintenance requests seeking partial flushing. The behaviour modifying circuitry thus is able to avoid the broadcast receiving processing element repeatedly having to respond to individual partial flushing requests and instead a full flush operation (upgraded maintenance operation) can be performed once and the need for further maintenance operations and their impact on subsequent processing performance can thereby be avoided.

In some embodiments either or both of the broadcast receiving processing element and/or the broadcast generating processing element may contain a data store which tracks on a per virtual machine execution environment basis whether a particular broadcast receiving processing element contains any state associated with the virtual machine execution environments. This data store can thus provide information to the behaviour modifying circuitry and allow this to suppress the further maintenance operation when the data store indicates that the given virtual machine execution environment does not have any state within the broadcast receiving processing element.

As previously mentioned, the predetermined condition under which the behaviour modifying circuitry modifies the behaviour associated with the further broadcast maintenance request can vary. One such condition is that the broadcast receiving processing element has not executed any program instructions using the given virtual machine execution environment since the maintenance operation associated with the first broadcast maintenance request triggered its response within the receiving processing element. As an example, if the broadcast receiving element has already flushed all of its data associated with the given virtual machine execution environment and has not executed any instructions for that given virtual machine execution environment in the intervening period, then a subsequently received further broadcast maintenance request in relation to the given virtual machine execution environment requiring further flushing of state may be ignored since no state associated with that given virtual machine execution environment is present within the broadcast receiving processing element.

A further example of the predetermined condition that may be met to trigger action of the behaviour modifying circuit is that the rate at which the broadcast generating circuitry seeks to generate broadcast maintenance messages exceeds a predetermined rate limit. This feature recognises that broadcast maintenance operations while necessary should be relatively rare events. Accordingly, limiting the rate of issue of broadcast maintenance requests should not unduly impact nominal behaviour of the system, but will prevent an excessive rate of issue of such broadcast maintenance messages causing undesired performance impacts between virtual machine execution environments that all ideally performance isolated from each other.

Such a rate limiting predetermined condition may be conveniently employed at the broadcast maintenance request source and accordingly applied by the broadcast generating processing element.

In other embodiments, the behaviour modifying circuitry may act at the broadcast receiving processing element. In this context the broadcast maintenance request may already have been issued and the action of the behaviour modifying circuitry can be to suppress triggering of a maintenance operation in response to receipt of the further broadcast maintenance message. The broadcast generating processing element completes its instruction and sends the further broadcast maintenance request, but the broadcast receiving processing element ignores that further broadcast maintenance request.

One efficient way of providing such behaviour within the system is when said behaviour modifying circuitry is configured to record with status data if said maintenance operation has been performed in response to said first broadcast maintenance message during execution of program instructions within a current one of said plurality of virtual machine execution environments by said broadcast receiving processing element and to suppress triggering of a maintenance operation in response to said further broadcast maintenance message unless at least one of:

said status data indicates that said maintenance operation has not been performed in response to said first broadcast maintenance message during execution of program instructions within said current one of said plurality of virtual machine execution environments; and

said given one of said plurality of virtual machine execution environments is the same as said current one of said plurality of virtual machine execution environments.

In this context it is appropriate that the status data is cleared when the broadcast receiving processing element changes to provide a different one of the plurality of virtual machine execution environments. When the broadcast receiving processing element switches the virtual machine execution environment it is supporting, then it is possible that a newly received broadcast maintenance request could have an impact upon the newly adopted virtual machine execution environment and accordingly should be actioned.

As previously discussed, the behaviour modifying circuitry may modify the behaviour of the further broadcast maintenance request to perform a modified broadcast maintenance request. This modified broadcast maintenance request can correspond to broadcast maintenance operations that are a superset of the maintenance operations specified by the original further broadcast maintenance request. Thus, the original request is upgraded into a request that is a superset of the original request, such as performing a more thorough maintenance operation in one go rather than performing multiple less thorough maintenance operations in a manner which would adversely impact performance isolation.

Another example of the possible action of the behaviour modifying circuitry is that it is configured to trigger an interrupt in processing by the broadcast receiving processing element and a switch to a hypervisor mode of operation in which the further broadcast maintenance request is selectively blocked. This switch to the hypervisor mode may take place immediately when the first further broadcast maintenance request is received from the same given virtual machine execution environment, or alternatively could take place, for example, after a threshold number of such further broadcast maintenance requests are received, either in absolute terms or within a predetermined period. Software processing within the hypervisor mode can then take appropriate action to either service the broadcast maintenance request, to suppress its action, or to stop further generation of such broadcast maintenance request.

It will be appreciated that in some embodiments a given processing element may comprise both broadcast request generating circuitry and broadcast request receiving circuitry.

In some embodiments all of the processing elements may comprise both broadcast request generating circuitry and broadcast request receiving circuitry.

As previously mentioned, the maintenance operations could take a variety of different forms. Such maintenance operations are typically, although not essentially, associated with the management of coherence within the system. On particular form of maintenance operation to which the present technique may be applied is maintenance operations concerning the flushing of state data locally stored within a broadcast receiving processing element. Such state data may be program instructions stored within a local instruction cache and the broadcast specifying instruction may be one or more of a partial invalidate instruction or a full invalidate instruction for selectively, under program control, invalidating a portion of the cached instructions or all of the cached instructions at a broadcast receiving processing element.

Viewed from another aspect the present invention provides apparatus for processing data comprising:

a plurality of processing means each for executing a stream of program instructions, said plurality of processing means providing a plurality of virtual machine execution environments; wherein

at least one of said plurality of processing means is a broadcast generating processing means having broadcast request generating means for generating a first broadcast maintenance request in respect of a given one of said plurality of virtual machine execution environments;

at least one of said plurality of processing means is a broadcast receiving processing means having broadcast request receiving means for receiving said first broadcast maintenance request from said broadcast generating processing means and for triggering a maintenance operation in said broadcast receiving processing means in response said first broadcast maintenance request; said apparatus further comprising:

behaviour modifying means for modifying behaviour of a further broadcast maintenance request in respect of said given one of said plurality of virtual machine execution environments if a predetermined condition is met.

Viewed from a further aspect the present invention provides a method of processing data comprising the steps of:

executing respective streams of program instructions with a plurality of processing elements, said plurality of processing elements providing a plurality of virtual machine execution environments; wherein

generating a first broadcast maintenance request in respect of a given one of said plurality of virtual machine execution environments using a broadcast generating processing element within said plurality of processing elements;

receiving said first broadcast maintenance request from said broadcast generating processing element at a broadcast receiving processing element of said plurality of processing elements;

triggering a maintenance operation in said broadcast receiving processing element in response said first broadcast maintenance request; and

modifying behaviour of a further broadcast maintenance request in respect of said given one of said plurality of virtual machine execution environments if a predetermined condition is met.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates a data processing system including a plurality of data processing elements;

FIG. 2 schematically illustrates a data processing element which performs broadcast message modification at reception;

FIG. 3 schematically illustrates a processing element which performs broadcast message modification at generation;

FIG. 4 schematically illustrates broadcast message modification circuitry which may be disposed between, but separate from, the processing elements;

FIGS. 5 and 6 together illustrate one example type of control which may be used within a broadcast receiving processing element to modify the behaviour of received broadcast maintenance requests;

FIG. 7 is a flow diagram schematically illustrating the upgrade of a partial invalidate message to a full invalidate request;

FIG. 8 is a flow diagram schematically illustrating the trapping of partial invalidate request after a full invalidate request has already been actioned;

FIG. 9 is a flow diagram schematically illustrating the filtering of full invalidate request after a full invalidate request has already been actioned at a given broadcast receiving processing element;

FIG. 10 is a flow diagram schematically illustrating processing which traps a received broadcast maintenance request to a hypervisor mode for software handling;

FIG. 11 is a flow diagram schematically illustrating message rate control which may be applied at a broadcast generating processing element; and

FIG. 12 is a flow diagram schematically illustrating how a full invalidate request may be trapped if one has already been performed and the processing element has not changed its virtual machine in the intervening period.

### DESCRIPTION OF THE EMBODIMENTS

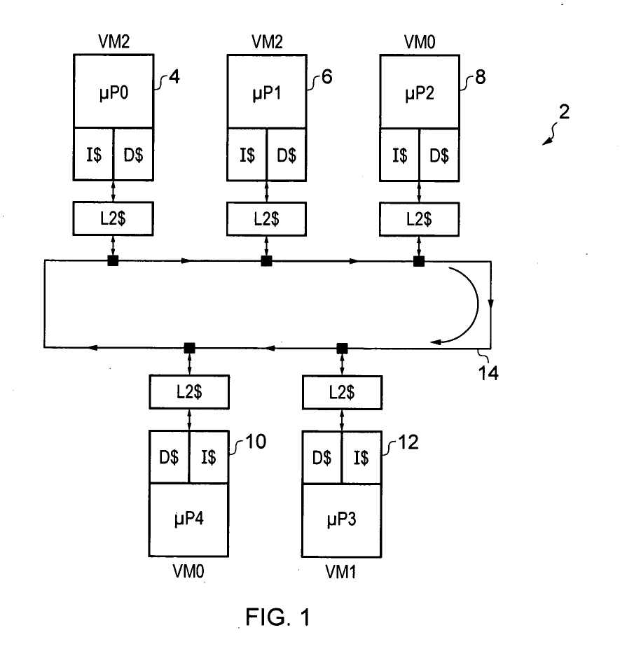

FIG. 1 schematically illustrates a data processing system 2 comprising a plurality of processing elements 4, 6, 8, 10, 12 connected via a ring bus 14. Messages (requests) may be passed between the processing elements 4, 6, 8, 10, 12 around the ring bus 14. These messages may include broadcast maintenance requests (also referred to as broadcast maintenance messages) for managing the coherence of data between the different processing elements 4, 6, 8, 10, 12. One example of such broadcast maintenance messages are instruction cache invalidation broadcast maintenance messages. These may instruct the flushing of the entire instruction cache at the broadcast receiving processing element or the flushing of selected lines of data within the broadcast receiving processing element. In either case, the time taken to perform such flushing operations will adversely impact the performance that could otherwise be achieved by that processing element. This adversely impacts virtual machine isolation between the processing elements. Furthermore, the flushing of instructions from the instruction cache may mean that instructions need to be re-fetched to that instruction cache before the processing element concerned may recommence its processing operations. It will be appreciated that such instruction cache flushing broadcast maintenance operations are only one example of the type of operations which may adversely impact virtual machine performance isolation. The state distributed between the processing elements can take other forms, such as data to be processed, or configuration data. The present techniques also can be usefully applied to avoid undesired effects in these other circumstances.

The data processing system 2 illustrated in FIG. 1 utilises a ring bus 14. It will be appreciated that other forms of communication may also be provided between the processing elements 4, 6, 8, 10, 12, such as a conventional interconnect. It will be further appreciated that the processing elements 4, 6, 8, 10, 12 illustrated in FIG. 1 are all in the form of processor cores including local instruction, data and level 2 caches. Different sorts of processing elements may also usefully utilise the present techniques, such as graphics processing units, DSP units, IO units, etc.

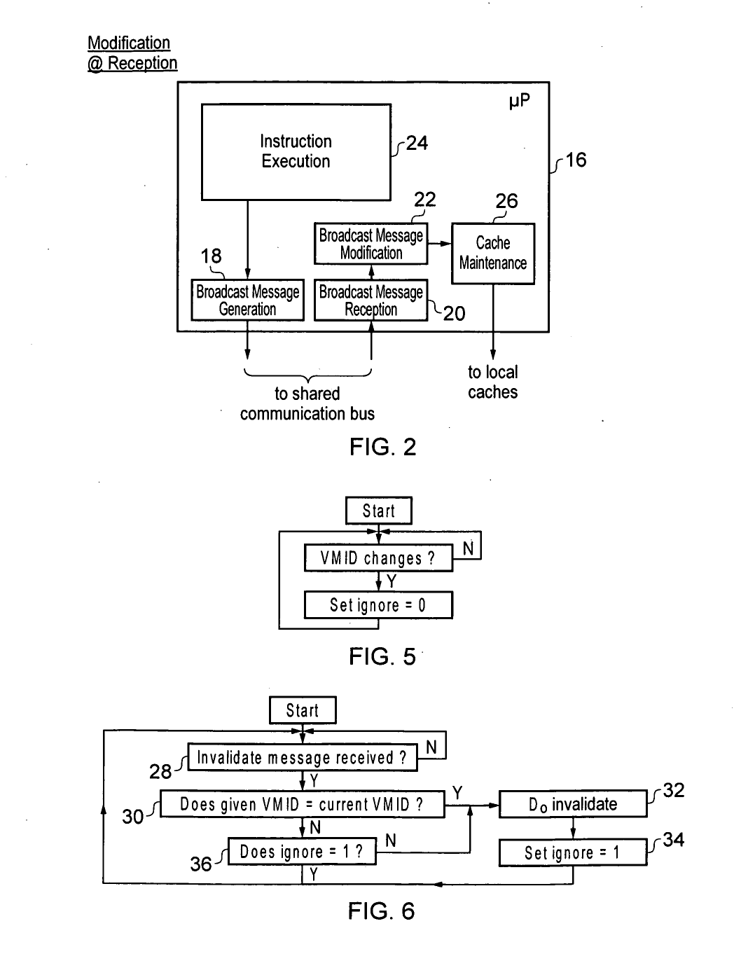

FIG. 2 schematically illustrates a processing element 16 including broadcast request generating circuitry 18, broadcast request receiving circuitry 20 and broadcast modification circuitry 22. Instruction execution circuitry 24 executes instructions, such as broadcast specifying instructions. Such broadcast specifying instructions may be executed in a user mode, a guest operating system or a hypervisor mode. When executed, such broadcast specifying instructions trigger the generation of broadcast maintenance requests which are sent to other processing elements. The broadcast request generating circuitry 18 sends such broadcast maintenance requests via a shared communication bus, such as the ring bus 14, to the other data processing elements 4, 6, 8, 10, 12 within the data processing system 2.

The data processing element 16 is also equipped with broadcast request receiving circuitry 20. This receives broadcast maintenance requests from other processing elements and passes these request to broadcast modification circuitry 22. The broadcast modification circuitry 22 can selectively modify the received broadcast maintenance requests in dependence upon whether one or more predetermined conditions are met. In this example embodiment, the broadcast maintenance requests relate to local cache maintenance and accordingly the original broadcast maintenance requests (and any appropriate modified broadcast maintenance requests) are passed on to cache maintenance circuitry 26 which then performs cache maintenance operations upon the local caches for the processing element 16. Example different types of predetermined conditions triggering modification as well as example different types of broadcast message modification that may be applied will be discussed further below.

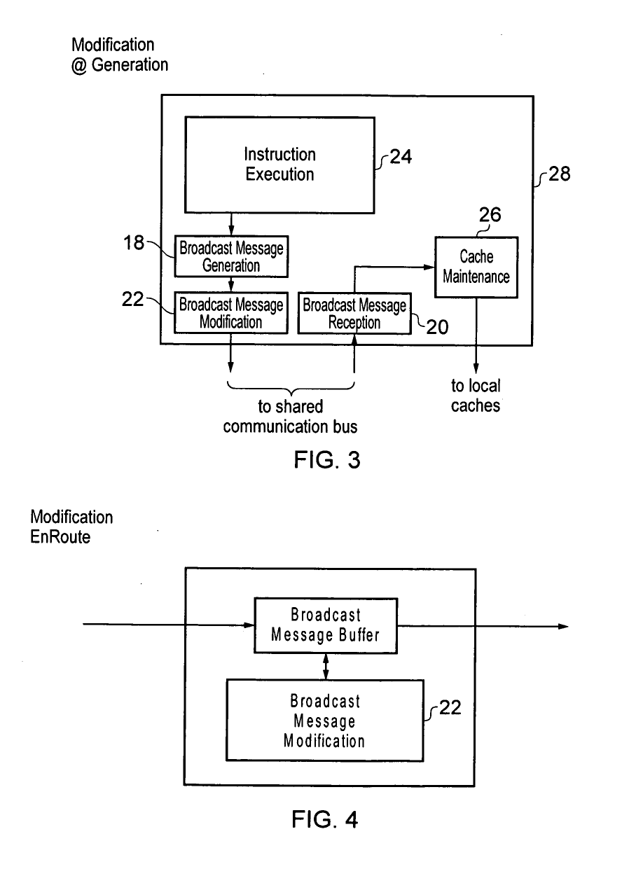

FIG. 3 schematically illustrates a processing element 28 similar to that illustrated in FIG. 2 except that the behaviour modification circuitry 22 is located so as to modify the broadcast maintenance requests as they are generated by the broadcast request generating circuitry 18 and before they are sent out to the other processing elements 4, 6, 8, 10, 12. Thus, behaviour modification can be applied at source, such as upgrading of broadcast maintenance requests, stalling of completion of execution of broadcast specifying instructions (thereby deferring generation of their associated broadcast maintenance requests), suppression altogether of broadcast maintenance request generation and the like.

It will be appreciated that the behaviour modification circuitry 22 may have a data store in which it stores data tracking the state of the data processing system 2 as a whole. As an example, the data stall may store on a per virtual machine execution environment basis whether or not a particular processing element 4, 6, 8, 10, 12 is storing any state data relating to that virtual machine execution environment. If the status store indicates that no such state data for a given virtual machine is stored when a broadcast maintenance message is either being generated or received, then such a broadcast maintenance message may be suppressed and no action taken. It will be appreciated that a data store may more appropriate be provided when broadcast message modification is performed at the receiver, as each broadcast receiving processing element need only be responsible for tracking its own state data and will be able to modify the behaviour of broadcast maintenance messages it receives in dependence upon its own locally stored data.

FIG. 4 schematically illustrates how the behaviour modification circuitry 22 may be disposed within processing circuitry located between processing elements which are exchanging broadcast maintenance messages. In the example of the ring bus 14 illustrated in FIG. 1, such processing circuitry may be disposed inline along the ring bus 18 so as to intercept and appropriately modify broadcast maintenance messages passing through it before they reach the destination broadcast receiving processing element(s).

FIGS. 5 and 6 are flow diagrams schematically illustrating one type of control which the behaviour modification circuitry (broadcast message modification circuitry) 22 may apply. The flow diagram of FIG. 5 serves to set a variable “ignore” to a value of “0” whenever the virtual machine execution environment being hosted by a given processing element changes.

In the flow diagram of FIG. 6, step 28 waits until an invalidate message is received. Step then determines whether or not the given virtual machine execution environment identifier that is the source of the invalidate message matches the virtual machine execution environment identifier of the virtual machine execution environment currently being hosted by the receiving processing element. If there is a match, then step 32 performs the invalidate operation. Step 34 then sets the “ignore” variable to “1” to indicate that subsequent invalidate operations can be ignored when received if there has been no change in the current virtual machine.

If the test at step 30 did not result in a match, then processing proceeds to step 36 where a determination is made as to whether or not the “ignore” variable has a current value of “0”. If the ignore variable does have such a value, then the invalidate is performed even though the current virtual machine identifier does not match the given machine virtual identifier. Accordingly, processing is passed to step 32 where the invalidate is performed and step 34 where the “ignore” variable is set to “1” such that subsequent invalidate requests from non-matching virtual machines will be ignored.

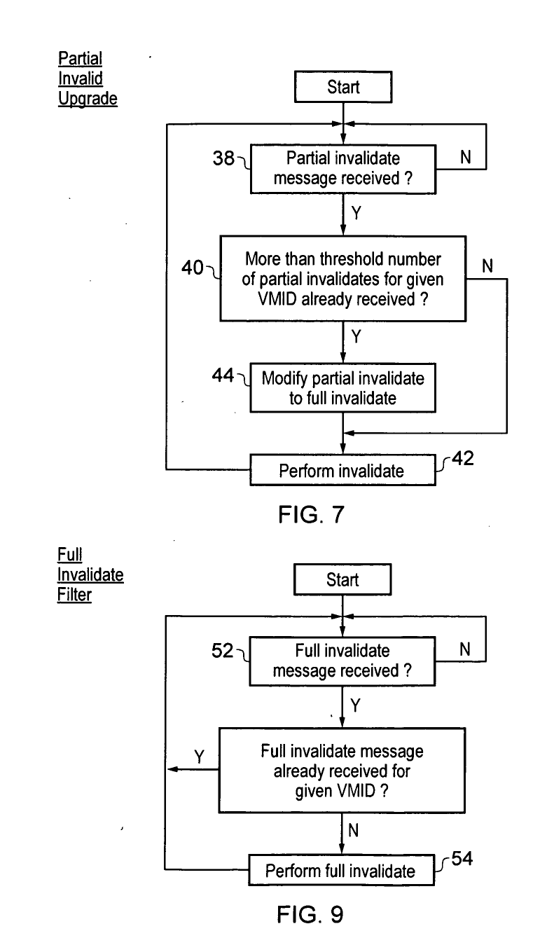

FIG. 7 schematically illustrates the upgrading of a partial invalidate maintenance message which may be performed by the behaviour modifying circuitry 22. Step 38 waits until a partial invalidate message is received. Step 40 then determines whether greater than a threshold number of partial invalidate messages for a given virtual machine identifier have already been received. If less than this threshold number of partial invalidate messages have currently been received, then processing proceeds to step 42 where the partial invalidate operation is performed before processing returns to step 38.

If the determination at step 40 is that greater than the threshold number of partially invalidates have already been received from the given virtual machine execution environment, then processing passes to step 44 where the partial invalidate broadcast maintenance request is upgraded to a full invalidate broadcast maintenance request. As an example, the partial invalidate broadcast maintenance request may request the invalidation of selected instructions stored at specified instruction addresses within a local instruction cache. In contrast, a full invalidate broadcast maintenance message may request the flushing of the entire local instruction cache. The full invalidate is a superset of the partial invalidate. The flow diagram in FIG. 7 exploits the realisation that in some circumstances it is more efficient to perform a full flush once rather than repeatedly interrupt processing at a broadcast receiving processing element in order to perform a partial invalidate. Once a full invalidate has been performed, then any subsequent partial invalidations may be ignored with safety.

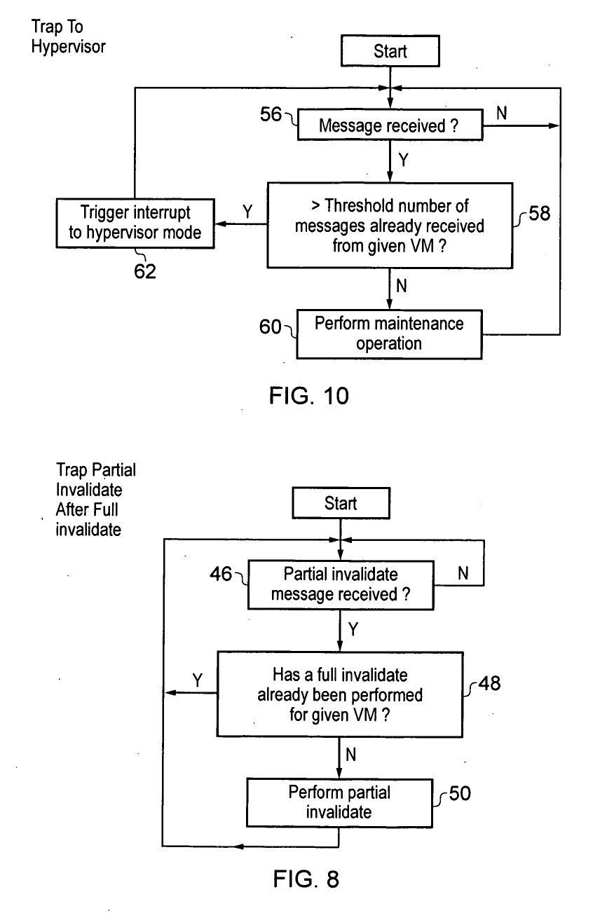

FIG. 8 is a flow diagram schematically illustrating how partial invalidate messages may be trapped and ignored. Step 46 waits until a partial invalidate message is received. Step 48 then determines whether a full invalidate has already been performed for the instruction cache in respect of the given (source) virtual machine execution environment which originated the partial invalidate request received at step 46. If such a full invalidate has already been performed, then the received partial invalidate message from step 46 may be ignored and processing returned to step 46. If such a full invalidate has not already been performed as determined at step 48, then step 50 serves to execute that partial invalidate. Step 50 corresponds to the behaviour modifying circuitry 22 not modifying the broadcast maintenance message and passing the partially invalidate through to the cache maintenance circuitry 26 unaltered. The ignoring of the received partial invalidate message that may be performed as a consequence of the determination at step 48 corresponds to a modification of the behaviour associated with that received partial invalidate message.

FIG. 9 is a flow diagram schematically illustrating how full invalidate messages may be filtered. This flow diagram is similar to FIG. 8, except that step 52 waits for full invalidate messages to be received and step 54 performs such full invalidate messages if they are not being ignored.

FIG. 10 is a flow diagram schematically illustrating another example form of behaviour modification in which case a received broadcast maintenance request is trapped for processing by software within a hypervisor mode. Step 56 waits until a broadcast maintenance message is received. Step 58 then determines whether greater than a threshold number of broadcast maintenance messages have already been received from a given virtual machine execution environment. If less than this threshold number of broadcast maintenance messages have already been received, then step 60 serves to perform the broadcast maintenance operation specified by the broadcast maintenance request received at step 56. If greater than the threshold number of messages have been received as determined at step 58, then processing proceeds to step 62 where an interrupt is triggered to switch processing at the broadcast receiving processing element into the hypervisor mode and execution of hypervisor software instructions. These hypervisor software instructions can analyse the received broadcast maintenance message and modify its behaviour, e.g. ignore it, upgrade it etc. The hypervisor software may also take action to prevent further inappropriate generate of broadcast maintenance messages if necessary. As an example, if the hypervisor software identifies that a particular processing element is generating too many broadcast maintenance messages, then the processing on that errant processing element may be stopped so as to avoid undesired performance interference between virtual machines within the data processing system 2.

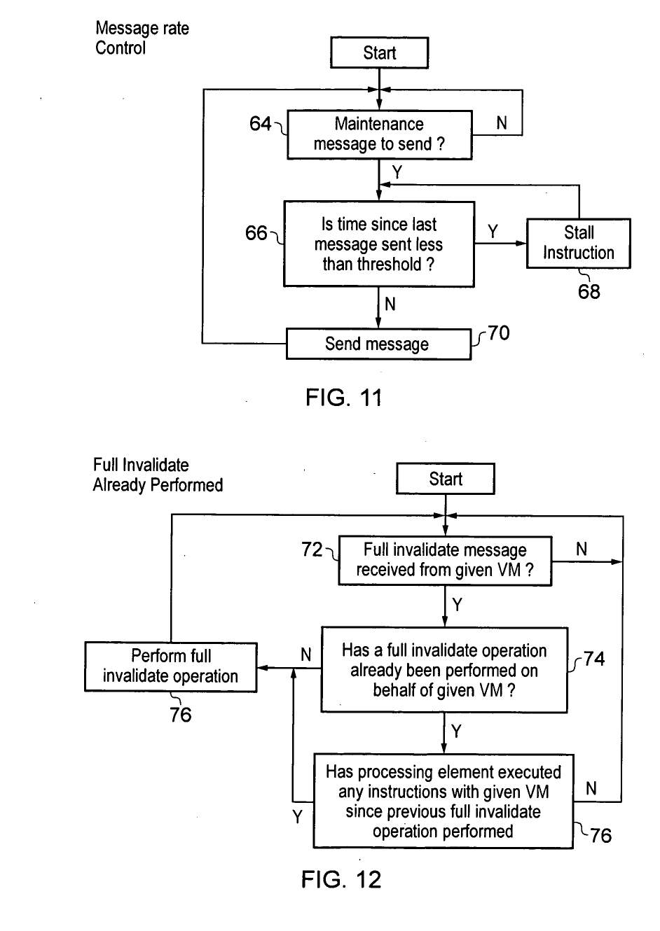

FIG. 11 is a flow diagram schematically illustrating how the behaviour modifying circuitry 22 may serve to identify a predetermined condition resulting in a need to modify the behaviour of a further broadcast maintenance request. This example predetermined condition is that the rate of message generation is too high. The control illustrated in FIG. 11 is particularly suited for application at a broadcast generating processing element to stop the generation of too many broadcast maintenance requests at source. Step 64 waits until there is a broadcast maintenance request to send. Step 66 then determines whether or not the time since the last broadcast maintenance message was sent from that broadcast generating processing element is less than a predetermined threshold. If the time is less than this threshold, then step 68 stalls the associated broadcast request generated instruction from execution until the time threshold applied at step 66 has been exceeded. When the threshold time examined at step 66 has been exceeded, then processing proceeds to step 70 where the broadcast maintenance message is sent.

It will be appreciated that the rate control illustrated in FIG. 11 is simple in this example. More sophisticated rate control mechanisms may be employed, such as for example sending the first N messages without applying any rate control and subsequently applying rate control until a predetermined period has expired in which no messages have been sent. Many other forms of rate control mechanism may also be envisaged and are encompassed within the present techniques.

FIG. 12 is a flow diagram schematically illustrating how a full invalidate maintenance operation may be suppressed when one has already been performed. Step 72 waits for a full invalidate method to be received from a given virtual machine.

Step 74 then determines whether or not a full invalidate operation has already been performed on behalf of the given virtual machine. If such a full invalidate operation has not already been performed on behalf of the given virtual machine, then step 76 serves to perform the full invalidate operation and processing is returned to step 72. If a full invalidate operation has already been performed on behalf of the given virtual machine, then step 76 serves to determine whether or not the processing element which received the invalidate request at step 72 has executed any instructions within the given virtual machine since the previous full invalidate operation was performed in respect of that given virtual machine. If there have not been any such instructions performed, then processing is returned to step 72, otherwise processing is passed to step 76 where the full invalidate operation is again performed.

It will be seen from the above that the behaviour modifying operations can take a wide variety of different forms. The behaviour modification may be performed to the messages (requests) either at source, at destination or on route. The predetermined conditions under which broadcast maintenance request modifications are performed can also vary. Modifications may or may not be performed depending upon, for example, the rate of message generation or state data tracked in respect of the different virtual machines which may be supported by the system 2, or state data indicating whether or not overlapping maintenance operations have already been performed rendering the new maintenance operation effectively redundant, etc. All of these techniques stem from the recognition that broadcast maintenance requests within a system employing a plurality of processing elements and supporting a plurality of different virtual machine execution environments can introduce undesired performance interference between the virtual machine execution environments. Having recognised this problem, the present techniques provide solutions employing a variety of different behaviour modification techniques triggered in dependence upon a variety of different predetermined conditions being detected. All of these variants are encompassed by the present techniques.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1. Apparatus for processing data comprising:
a plurality of processing elements each configured to execute a stream of program instructions, said plurality of processing elements providing a plurality of virtual machine execution environments; wherein
at least one of said plurality of processing elements is a broadcast request generating processing element having broadcast generating circuitry configured to generate a first broadcast maintenance request in respect of a given one of said plurality of virtual machine execution environments;
at least one of said plurality of processing elements is a broadcast request receiving processing element having broadcast receiving circuitry configured to receive said first broadcast maintenance request from said broadcast generating processing element and to trigger a maintenance operation in said broadcast receiving processing element in response said first broadcast maintenance request; said apparatus further comprising:
behaviour modifying circuitry configured to modifying behaviour of a further broadcast maintenance request in respect of said given one of said plurality of virtual machine execution environments if a predetermined condition is met.

2. Apparatus as claimed in claim 1, wherein said first broadcast maintenance request is generated in response to execution of a first broadcast specifying instruction by said broadcast generating processing element and said further broadcast maintenance request is generated in response to execution of a further broadcast specifying instruction.

3. Apparatus as claimed in claim 1, wherein predetermined behaviour of said further broadcast maintenance request is modified based on information from said first broadcast maintenance request.

4. Apparatus as claimed in claim 3, wherein said predetermined behaviour is modified based on virtual machine execution environment state maintained within said broadcast generating processing element.

5. Apparatus as claimed in claim 3, wherein said predetermined behaviour is modified based on virtual machine execution environment state maintained within said broadcast receiving processing element.

6. Apparatus as claimed in claim 3, wherein said predetermined behaviour is modified based on virtual machine execution environment state maintained within one of said plurality of processing elements other than said broadcast generating processing element and said broadcast receiving processing element.

7. Apparatus as in claim 2, wherein behaviour modifying circuitry is configured to modify behaviour by stalling completion of said further broadcast specifying instruction and thereby deferring generation of said further broadcast maintenance request.

8. Apparatus is in claim 1, wherein the behaviour modifying circuitry upgrades said further broadcast maintenance requests to result in an upgraded maintenance operation that has a larger scope than and includes a further maintenance operation directly corresponding to said further broadcast maintenance request.

9. Apparatus as in claim 8, wherein at least some other maintenance operations are not required after performing said upgraded maintenance operation.

10. Apparatus in claim 5, wherein said broadcast receiving processing element is configured to track within a data store presence within said broadcast receiving processing element of state associated with respective ones of said plurality of virtual machine execution environments and said behaviour modifying circuitry is configured to modify said further maintenance operation not to take action when said data store indicates that said given virtual machine execution environment does not have state with said broadcast receiving processing element.

11. Apparatus in claim 6, wherein said broadcast generating processing element is configured to track within a data store presence within said broadcast receiving processing element of state associated with respective ones of said plurality of virtual machine execution environments and said behaviour modifying circuitry is configured to modify said further maintenance operation not to take action when said data store indicates that said given virtual machine execution environment does not have state with said broadcast receiving processing element.

12. Apparatus as claimed in claim 1, wherein said predetermined condition is that said broadcast receiving processing element has not executed any program instructions using said given one of said plurality of virtual machine execution environments since said maintenance operation was triggered in response to said first broadcast maintenance request.

13. Apparatus as claimed in claim 1, wherein said predetermined condition is that a rate at which said broadcast generating circuitry seeks to generate broadcast maintenance messages exceeds a predetermined rate limit.

14. Apparatus as claimed in claim 1, wherein said behaviour modifying circuitry is coupled to said broadcast receiving processing element and is configured to modify behaviour by suppressing triggering of a maintenance operation in response to receipt of said further broadcast maintenance message by said broadcast receiving processing element.

15. Apparatus as claimed in claim 14, wherein said behaviour modifying circuitry is configured to record with status data if said maintenance operation has been performed in response to said first broadcast maintenance message during execution of program instructions within a current one of said plurality of virtual machine execution environments by said broadcast receiving processing element and to suppress triggering of a maintenance operation in response to said further broadcast maintenance message unless at least one of:
said status data indicates that said maintenance operation has not been performed in response to said first broadcast maintenance message during execution of program instructions within said current one of said plurality of virtual machine execution environments; and
said given one of said plurality of virtual machine execution environments is the same as said current one of said plurality of virtual machine execution environments.

16. Apparatus as claimed in claim 15, wherein said status data is cleared when said broadcast receiving processing element changes to providing a different one of said plurality of virtual machine execution environments.

17. Apparatus as claimed in claim 1, wherein said behaviour modifying circuitry is configured to modify behaviour by modifying said further broadcast maintenance request to form a modified broadcast maintenance request corresponding to modified broadcast maintenance operations that are a superset of said maintenance operation specified by said further broadcast maintenance request.

18. Apparatus as claimed in claim 1, wherein said behaviour modifying circuitry is configured to modify behaviour by triggering an interrupt in processing by said broadcast receiving processing element and a switch to a hypervisor mode of operation in which said further broadcast maintenance request is selectively blocked.

19. Apparatus as claimed in claim 1, wherein at least some of said plurality of processing elements comprise both broadcast request generating circuitry and broadcast request receiving circuitry.

20. Apparatus as claims in claim 19, wherein all of said plurality of processing elements comprise both broadcast request generating circuitry and broadcast request receiving circuitry.

21. Apparatus as claimed in claim 1, wherein said maintenance operation is a flushing operation that flushes state data stored locally for said broadcast receiving processing element.

22. Apparatus as claimed in claim 21, wherein said state data comprises program instructions stored within an instruction cache of said broadcast receiving processing element.

23. Apparatus as claimed in claim 22, wherein said broadcast specifying instruction is an invalidate instruction executed by said broadcast generating processing element to trigger invalidation of program instructions stored within instruction caches of said plurality of processing elements.

24. Apparatus as claimed in claim 24, wherein said invalidation of program instructions acts to invalidate all program instructions stored within instruction caches of said plurality of processing elements.

25. Apparatus as claimed in claim 24, wherein said invalidation of program instructions acts to invalidate specified program instructions stored within instruction caches of said plurality of processing elements

26. Apparatus for processing data comprising:
a plurality of processing means each for executing a stream of program instructions, said plurality of processing means providing a plurality of virtual machine execution environments; wherein
at least one of said plurality of processing means is a broadcast generating processing means having broadcast request generating means for generating a first broadcast maintenance request in respect of a given one of said plurality of virtual machine execution environments;
at least one of said plurality of processing means is a broadcast receiving processing means having broadcast request receiving means for receiving said first broadcast maintenance request from said broadcast generating processing means and for triggering a maintenance operation in said broadcast receiving processing means in response said first broadcast maintenance request; said apparatus further comprising:
behaviour modifying means for modifying behaviour of a further broadcast maintenance request in respect of said given one of said plurality of virtual machine execution environments if a predetermined condition is met.

27. A method of processing data comprising the steps of:
executing respective streams of program instructions with a plurality of processing elements, said plurality of processing elements providing a plurality of virtual machine execution environments; wherein
generating a first broadcast maintenance request in respect of a given one of said plurality of virtual machine execution environments using a broadcast generating processing element within said plurality of processing elements;
receiving said first broadcast maintenance request from said broadcast generating processing element at a broadcast receiving processing element of said plurality of processing elements;
triggering a maintenance operation in said broadcast receiving processing element in response said first broadcast maintenance request; and
modifying behaviour of a further broadcast maintenance request in respect of said given one of said plurality of virtual machine execution environments if a predetermined condition is met.
